(19) United States
(12) Patent Application Publication
(10) Pub. No.: US 2007/0220601 A1
(43) Pub. Date: Sep. 20, 2007

(54) Diversified instruction set processor architecture for the enablement of virus resilient computer systems

(76) Inventors: Lorenz Francis Huelsbergen, Lebanon, NJ (US); Hubert Rae McLellan JR., Summit, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/368,251

(22) Filed: Mar. 3, 2006

(51) Int. Cl. G06F 12/14

(52) U.S. Cl. 726/22

(57) ABSTRACT

A Virus Resilient Processor (VRP) is obtained with use of a “Diverse Instruction Set Architecture” (DISA) comprising an assignment of differing sets of instruction codes (i.e., “opcodes” or operation codes) to different individual processors. In accordance with certain illustrative embodiments of the present invention, an individual “key” associated with a given processor is advantageously used to transform the set of instruction codes to (and from) a particular instruction set. And in accordance with one of these illustrative embodiments of the invention, the set of instruction codes is transformed by permuting (i.e., reordering) the bits of the instruction code in a specific manner based on the individual key. In this manner, since instruction code sets will be diverse across different processors, malicious code can be advantageously thwarted because an attacker will not know the mapping of opcodes to functionality.

### FIELD OF THE INVENTION

The present invention relates generally to the field of computer processor architectures and more particularly to a diversified instruction set processor architecture which advantageously enables the creation of virus resilient computer systems.

### BACKGROUND OF THE INVENTION

It is clear that malicious software in the form of viruses (including worms, etc.) is a large and growing menace to society. Viruses can completely hijack a machine, stealing or destroying its information. Furthermore, they can use the hijacked machine to steal personal identities or to launch larger attacks, such as denial of service attacks, on the wider internet.

Although improperly written and unsecured software is in part to blame—as are the actions of unwitting users—another cause of computer viruses being so virulent can be deduced by examining living organisms in nature. Nature is diverse, both in the number of different species of organisms it contains and in the “programming” of individual organisms within a species. Such diversity acts as a deterrent for rampant virus propagation since genetic (i.e., code) differences present a variety of targets to the virus. In order to successfully infect all targets, viruses must be highly complex which is a barrier to their existence.

On the other hand, computer viruses are rampant today in part because of a lack of diversity in the processors and operating systems used in most general computing platforms. Since there are only a handful of common operating systems (i.e., Windows®, Linux® and MacOS®), running predominantly on two or three instruction set architectures (e.g., x86® and PowerPC® architectures), virus writers have essentially a small fixed number of targets which they must be capable of attacking.

### SUMMARY OF THE INVENTION

We have recognized that computer system diversity may be advantageously created by making each platform appear to be essentially unique in the format of the code it runs. Thus, the resultant diversity in computing platforms will advantageously make virus creation much more difficult. In accordance with the principles of the present invention, these computer platforms are advantageously diversified by individually modifying their instruction sets on an essentially per-processor basis. We will refer herein to the resultant computer platforms as “Virus Resilient Processors” (VRP's), and we will refer herein to the enabling technology in accordance with the principles of the present invention as “Diverse Instruction Set Architectures” (DISA's). By so diversifying the computing platforms by individually modifying their instruction sets on a per-processor basis, vulnerability to viral infection is advantageously mitigated.

More particularly, in accordance with the principles of the present invention, a Diverse Instruction Set Architecture advantageously comprises an assignment of differing sets of instruction codes (i.e., “opcodes” or operation codes) to different individual processors. In accordance with certain illustrative embodiments of the present invention, an individual “key” associated with a given processor is advantageously used to transform the set of instruction codes to (and from) a particular instruction set. And in accordance with one of these illustrative embodiments of the invention, the set of instruction codes is transformed by permuting (i.e., reordering) the bits of the instruction code in a specific manner based on the individual key. In this manner, since instruction code sets will be diverse across different processors, malicious code can be advantageously thwarted because an attacker will not know the mapping of opcodes to functionality.

More specifically, the present invention provides a Diverse Instruction Set Architecture (DISA) computer system comprising (i) a processor core having a native instruction set architecture associated therewith, the processor core for executing instructions coded in the native instruction set architecture; (ii) a key memory for storing a fixed, predetermined key associated with the computer system; (iii) a program memory for storing software programs comprising instructions coded in an alternative instruction set architecture which differs from the native instruction set architecture, the difference between the alternative instruction set architecture and the native instruction set architecture based on the fixed, predetermined key; and (iv) a translation unit for transforming instructions comprised in software programs coded in the alternative instruction set architecture into corresponding instructions coded in the native instruction set architecture, the transformed instructions for execution by the processor core, the transformation based on said fixed, predetermined key.

In addition, the present invention provides a method of operating such a DISA computer system, the method comprising the steps of (i) retrieving from the program memory one or more instructions comprised in a software program coded in the alternative instruction set architecture and stored in the program memory; (ii) transforming, with use of the translation unit, the one or more retrieved instructions into one or more corresponding instructions coded in the native instruction set architecture, the step of transforming based on the fixed, predetermined key; and (iii) executing on the core processor the one or more corresponding instructions coded in the native instruction set architecture generated with use of the translation unit.

### BRIEF DESCRIPTION OF THE DRAWINGS

FIG. 1 shows a sample block diagram of a computing system with a processor having a Diverse Instruction Set Architecture in accordance with an illustrative embodiment of the present invention.

FIG. 2 shows the operation of a key based software conversion utility in accordance with an illustrative embodiment of the present invention, the conversion utility for use in converting system software and software applications for use with the illustrative processor of FIG. 1.

FIG. 3 shows the operation of an example of the translation unit of the illustrative processor of FIG. 1 for use in transforming the set of instruction codes in accordance with one illustrative embodiment of the present invention.

FIG. 4 shows a sample flowchart for implementing the illustrative translation unit of FIG. 3 in accordance with an illustrative embodiment of the present invention.

### DETAILED DESCRIPTION OF THE ILLUSTRATIVE EMBODIMENTS

In accordance with the principles of the present invention, unique (or almost unique) instruction codes (opcodes) are advantageously assigned to each individual processor. For example, a hypothetical instruction that adds the values in registers r1 and r2 and deposits the result in register r3—which would typically be written as “add r1, r2, r3”—will, with high probability, be encoded differently on the two processors. For example, the instruction may be encoded as “0111010011001010” on one processor and as “1101100011000001” on another processor (assuming a 16-bit instruction code on a 32-bit architecture processor).

Since, in accordance with the principles of the present invention instruction sets will advantageously be diverse across processors, malicious code can be thwarted because the attacker does not know the mapping of opcodes to functionality. Consider, for example, the well-known method of using buffer overruns to bootstrap a virus into a system. In such a scenario, an attacker uses a known buffer overrun condition to insert malicious code into the computer's memory and then to confer control to this malicious code. In accordance with the principles of the present invention, however, even though the attacker may be cognizant of improper buffer handling code in an application on the target system, he or she can only guess at the bit sequences that would perform intended malicious actions. Moreover, even if an attacker were to deduce the instruction code mapping for a single computer and infect it with a virus, the remainder of the population of processors employing DISA in accordance with the principles of the present invention would remain immune to the virus. Thus, the economy of scale exploited by virus writers today can be largely eliminated by DISA.

In accordance with certain illustrative embodiments of the present invention, a DISA processor may be advantageously designed in such a way that efficient operation and manufacture of processor cores is at most minimally impacted. At least one such illustrative embodiment is described in detail below. In addition, in accordance with certain illustrative embodiments of the present invention, a DISA processor is advantageously augmented with a software component that can customize an application (e.g., a web browser, editor, operating system, etc.) for the particular DISA processor.

More specifically, in accordance with certain illustrative embodiments of the present invention, a processor is adapted to comprise an essentially “unique” instruction set by the inclusion of a (preferably) hardware translation unit (TU), advantageously located between the computer's memory bus and its outer most instruction cache. (In accordance with various illustrative embodiments of the present invention, any of a number of possible points along the path from the memory to the execution pipeline could hold such a TU.) The task of the illustrative TU (in accordance with these illustrative embodiments of the invention) is to translate data on the instruction path from an encoded (“unique” or “diverse”) program representation which has been stored in memory into the processor's native ISA (Instruction Set Architecture), such as, for example, the native instruction set of x86 processors (assuming that the processor is an x86 processor).

In accordance with certain illustrative embodiments of the present invention, this may be advantageously accomplished with the use of a specific, pre-defined “key,” wherein the particular key is associated with the given processor, and which may, for example, be stored in non-volatile (and preferably) write-once memory within the processor (e.g., within the TU). In particular, the key, which has been advantageously used previously to “encode” the program code being executed, may then be advantageously used by the TU to “decode” the program code.

In accordance with one illustrative embodiment of the present invention, the encoding initially performed (based on the key) may comprise a “shuffling” (e.g., a permutation) of the bits within a word-size data quantity, and the decoding may comprise a corresponding “un-shuffling” of the bits within the word-size data quantity. Any number of possible shufflings or, illustratively, permutations, may be used, advantageously selected based on the associated key. By way of a simple example, one such shuffling and un-shuffling may comprise merely reversing the order of the bits. More generally, however, in accordance with certain illustrative embodiments of the present invention, a programmable network may be advantageously used within the TU to achieve a variety of possible (and, in general, more complex) shufflings or permutations of the bits, which may be advantageously determined based on the particular key (e.g., a “permutation key”) which is associated with the given processor. In accordance with other illustrative embodiments of the present invention, any of a number of alternative coding schemes, other than, for example, simple bit permutation, each of which will be obvious to those of ordinary skill in the art, may be used to transform the instruction set of a DISA processor. (By way of one other simple example, an XOR function may be applied to the bits of an instruction in order to transform the instruction set of a DISA processor in accordance with one illustrative embodiment of the present invention.)

Note that, in accordance with these illustrative embodiments of the present invention, the key is advantageously used initially for installing new software for the processor (including, for example, the initial operating system software and other initially supplied software), since the illustrative processor, by using the key and the TU to un-shuffle the bit order, will only successfully run programs previously encoded with use of this key. Thus, any software that is installed on this DISA system is advantageously pre-processed with the key before installation. This pre-processing is advantageously performed for off-the-shelf applications, code generated by a compiler, and mobile code downloaded on the web, for example.

In accordance with one illustrative embodiment of the present invention, the permutation key is advantageously provided in a manner which is unreadable by user programs once it has been written into the TU. Thus, it is hidden from software running on the DISA processor, thereby ensuring its security against any possible discovery by a malicious attacker. In accordance with other illustrative embodiments of the present invention, however, the key may be embedded in software to enable a DISA system to be implemented with minimal processor modifications.

Note that the DISA scheme in accordance with various illustrative embodiments of the present invention does not drastically impact current processor designs since, advantageously, after un-shuffling, the data words in the instruction path are native instructions that can be executed as such. In accordance with certain illustrative embodiments of the present invention, instruction operands (immediate operands, memory addresses, etc.) may be advantageously encoded and then subsequently decoded by a DISA processor in an analogous manner and thus require no special treatment. In addition, note that variable length ISA's (such as that of the x86, for example) are easily handled by the illustrative embodiments of the present invention described herein, since translation is advantageously performed before the decode stage on cache-line units or words. The encoding process of the programs, which may be advantageously performed by a software utility as pointed out above (and described in further detail below), can easily respect this constraint when converting instructions.

As pointed out above, in accordance with certain illustrative embodiments of the present invention, the conversion (i.e., encoding) of programs into code for the specific DISA processor may be advantageously performed via certain supporting software. In particular, in accordance with these illustrative embodiments of the present invention, a “bootstrap” process advantageously initializes a new DISA processor instance and creates the custom application software which may be executed thereon. It may be assumed, for example, that an un-initialized DISA processor will execute programs written in its native instruction set (as conventional processors invariably do presently), and is hence open to viruses. The following describes the operation of this bootstrap process in accordance with these illustrative embodiments of the present invention.

In particular, a software module referred to as a conversion utility (CU) is advantageously included with the computing system containing the un-initialized DISA processor. Also running on this illustrative computing system is a minimal operating system, OS, that essentially permits only operation of the CU, but no other software. The illustrative CU is initially a conventional program that runs natively (i.e., executes based on the native ISA of the processor).

Then, in accordance with these illustrative embodiments of the present invention, upon invocation, the CU prompts the user for a specific key, K, for this particular DISA processor, P. Upon input to the CU, the key K is advantageously first used to create a new version of the CU, called CU_{K}. (Note that CU_{K} advantageously does not contain the key K, but contains only instructions which have been encoded with the key K.) The CU is then also advantageously run on the minimal OS, and advantageously produces a new version of the minimal operating system, OS_{K} as a result. Next, after installing OS_{K} and ensuring that it will be booted (as opposed to the original minimal operating system, OS) on the next reboot of the system, CU sets the new key in the write-once memory in the TU. (Illustratively, the act of setting the key may itself advantageously initiate an immediate system reboot.) Once rebooted, the processor will now advantageously operate only on programs written in its diversified (i.e., transformed) instruction set, and may be denoted as processor P_{K}.

As pointed out above, upon reboot with the key installed, the system advantageously boots the minimal operating system OS_{K} which has at its disposal CU_{K}. In the context of an assigned key, K, CU_{K} may now be advantageously used to convert software applications to run on P_{K}. In particular, CU_{K} is advantageously provided K as input for each program that is to be converted to P_{K}'s transformed instruction set. Illustratively, the first “application” to be converted may advantageously be a full-blown Operating System, such as, for example, MacOS® or Windows®.

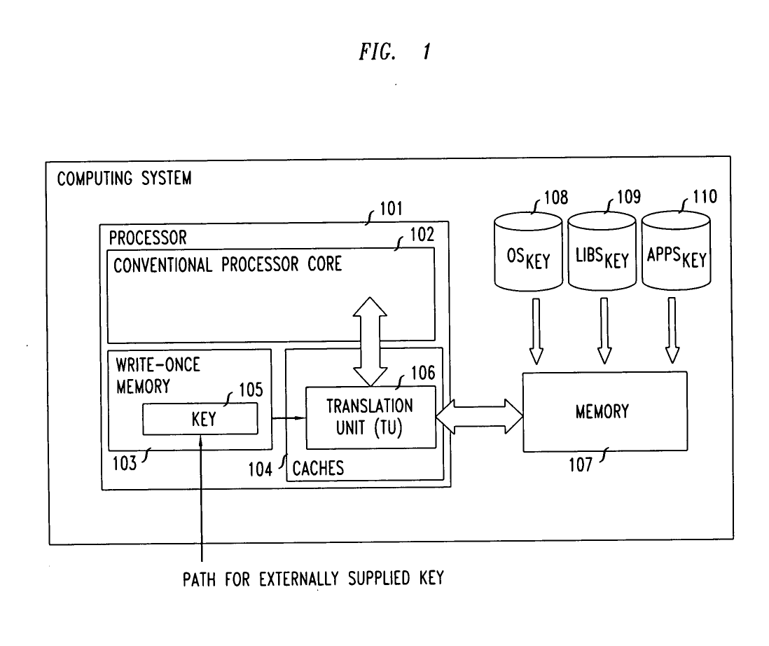

FIG. 1 shows a sample block diagram of a computing system with a processor having a Diverse Instruction Set Architecture in accordance with an illustrative embodiment of the present invention. The illustrative system of FIG. 1 comprises DISA processor 101, which comprises conventional processor core 102, which operates on the native instruction set (e.g., x86) of the conventional processor type; write-once memory 103; and caches 104. Write-once memory comprises key 105, which has been externally supplied and written into the memory during the (one-time) processor initialization. And cache 104 comprises translation unit (TU) 106, which operates to transform diverse (i.e., encoded) instruction codes into native instruction codes for conventional processor core 102.

The illustrative computing system of FIG. 1 also comprises memory 107 and various software modules, each of which has been converted to operate on the illustrative DISA processor with the given key—namely, key 105. Shown specifically in the figure are converted operating system 108 (OS_{key}), converted libraries 109 (Libs_{key}), and converted applications 110 (Apps_{key}), each of which may be loaded into memory 107 for subsequent execution by DISA processor 101.

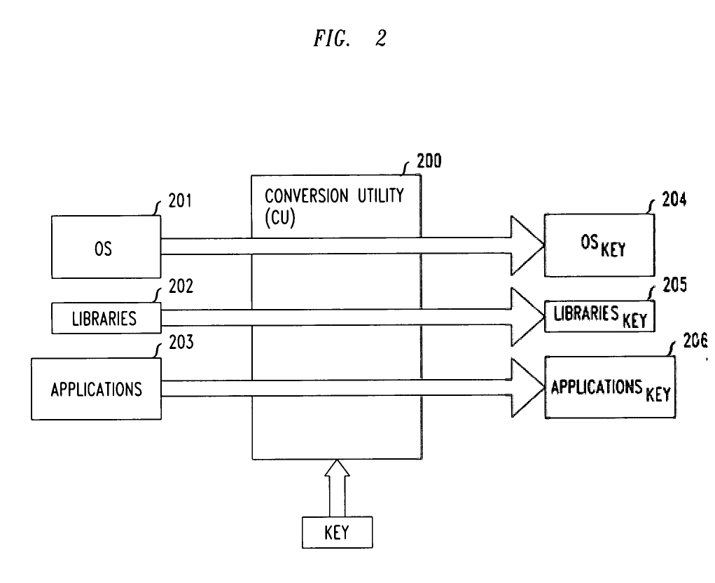

FIG. 2 shows the operation of a key based software conversion utility in accordance with an illustrative embodiment of the present invention, the conversion utility for use in converting system software and software applications for use with the illustrative processor of FIG. 1. Conversion utility (CU) 200 is used to convert both system software and application software to modified versions which may be executed on DISA 101 processor 101 of FIG. 1. Specifically shown is the conversion of operating system (OS) 201, libraries 202, and applications 203 into converted operating system 204 (OS_{key}), converted libraries 205 (Libraries_{key}), and converted applications 206 (Applications_{key}), respectively, based on provided key 207.

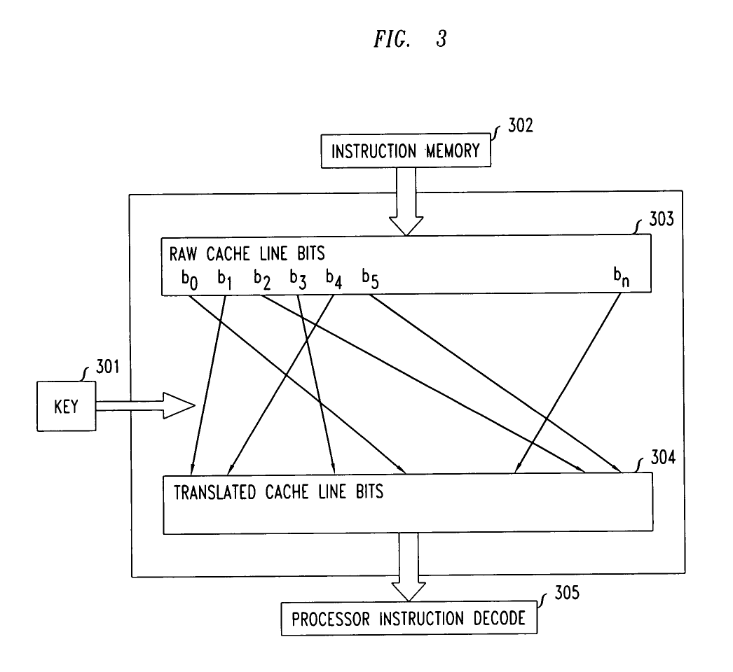

FIG. 3 shows the operation of an example of the translation unit of the illustrative processor of FIG. 1 for use in transforming the set of instruction codes in accordance with one illustrative embodiment of the present invention. The example TU operates based on key 301, and receives raw cache line bits 303 from instruction memory 302. In operation, the cache line bits are permuted, based on key 301, to produce translated cache line bits 304, which are then sent to processor instruction decode 305.

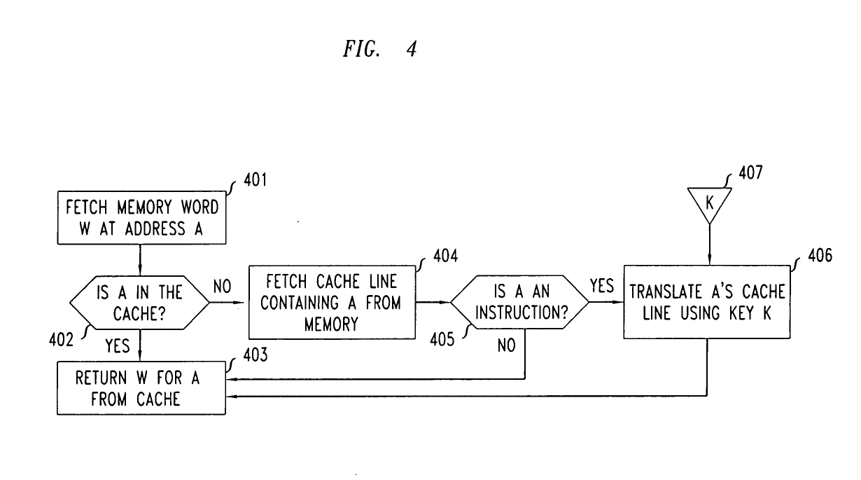

FIG. 4 shows a sample flowchart for implementing the illustrative translation unit of FIG. 3 in accordance with an illustrative embodiment of the present invention. The sample flowchart begins in block 401 with a fetch of a memory word, W, at an address, A. Then, decision block 402 determines whether address A is in the processor cache. If it is, block 403 simply returns word W from the cache.

If address A is not in the processor cache, however, block 404 fetches the cache line containing address A from memory. Then, decision block 405 determines whether address A is an instruction. If it is not, flow proceeds to block 403 where word W is returned from the cache. If, however, address A is an instruction, block 406 uses key (K) 407 to translate address A's cache line in accordance with the principles of the present invention, and then, flow proceeds to block 403 where word W is returned from the cache.

Note that some applications allow generation of executable code on-the-fly. In accordance with one illustrative embodiment of the present invention, a DISA processor may advantageously be extended to support such functionality by providing an encode function based on the key, or, alternatively, a call to a software subroutine to perform the conversion.

It will be advantageous if applications used in connection with a DISA processor according to an illustrative embodiment of the present invention are structured in such a way that the code (text segments) can be converted directly by module CU_{K}. Conventional image formats (e.g., ELF, fully familiar to those of ordinary skill in the art) may be used to properly structure most applications with little or no modification. Note that data segments in particular need no special treatment or conversion, since they will not be fetched as part of the instruction stream.

Also note that statically linked applications will require no special treatment since all library routines will advantageously become part of the executable image and will hence be converted. Dynamically linked applications and re-locatable applications may be advantageously resolved at application load-time. In particular, in accordance with certain illustrative embodiments of the present invention, addresses assigned by the loader may be advantageously converted “on the fly” (by a call to a subroutine in CU_{K}, for example) to their encoded version. The encoded address may then be advantageously patched into the loaded image at the appropriate instruction locations.

Finally, although the above description has focused on the advantages of the present invention for purposes of creating virus resilient computer systems, another possible advantage of the use of the techniques in accordance with various illustrative embodiments of the present invention is the deterrence of software piracy. For the same reasons that a diverse instruction set architecture can protect against the unwanted installation of malicious code (e.g., viruses), such an architecture can make difficult, if not impossible, the illegal copying of software from one computer system to another. In particular, since, in accordance with the principles of the present invention, the executable code for a given software module has been advantageously transformed into a specific, diverse instruction set for a given processor, that same executable code cannot be merely copied from the given processor and used (as is) on another processor having a different (diverse) instruction set.

### ADDENDUM TO THE DETAILED DESCRIPTION

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. For example, in some illustrative embodiments of the present invention, multiple processor architectures, such as dual core processors, may be employed. In such embodiments, the processor core may comprise two or more individual processors, each of which executes the native ISA.

In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

We claim:

1. A computer system comprising:
a processor core having a native instruction set architecture associated therewith, the processor core for executing instructions coded in said native instruction set architecture;
a key memory for storing a fixed, predetermined key associated with the computer system;
a program memory for storing software programs comprising instructions coded in an alternative instruction set architecture which differs from said native instruction set architecture, said difference between said alternative instruction set architecture and said native instruction set architecture based on said fixed, predetermined key; and
a translation unit for transforming instructions comprised in software programs coded in said alternative instruction set architecture into corresponding instructions coded in said native instruction set architecture, said transformed instructions for execution by said processor core, said transformation based on said fixed, predetermined key.

2. The computer system of claim 1 wherein the key memory comprises a write-once memory.

3. The computer system of claim 2 wherein the fixed, predetermined key is accessible by the translation unit and is not accessible by user supplied software programs executable on said computer system.

4. The computer system of claim 1 wherein said instructions comprised in software programs coded in said alternative instruction set architecture comprise bitwise permutations of said corresponding instructions coded in said native instruction set architecture, said bitwise permutations being based on said fixed, predetermined key.

5. The computer system of claim 1 further comprising a conversion utility for transforming software programs coded in said native instruction set architecture into corresponding software programs coded in said alternative instruction set architecture, wherein said transformation of software programs by said conversion utility is based on said fixed, predetermined key.

6. The computer system of claim 5 further comprising an operating system implemented as a software program coded in said alternative instruction set architecture, said operating system having been generated with use of said conversion utility.

7. The computer system of claim 5 wherein said conversion utility is implemented as a software program coded in said alternative instruction set architecture.

8. The computer system of claim 7 wherein the computer system is initially supplied with a minimal operating system and an initial conversion utility, each of which is implemented as a software program coded in said native instruction set architecture, and wherein the minimal operating system and initial conversion utility are each executed on said processor core without use of said translation unit.

9. The computer system of claim 8 wherein said initial conversion utility is used to generate said conversion utility from said initial conversion utility, and wherein said initial conversion utility is further used to generate a converted minimal operating system from said minimal operating system, said converted minimal operating system implemented as a software program coded in said alternative instruction set architecture.

10. The computer system of claim 9 wherein, after said converted minimal operating system is generated from said minimal operating system, and after said conversion utility is generated from said initial conversion utility, said fixed, predetermined key is installed in said key memory and use of said translation unit is enabled.

11. A method of operating a computer system, the computer system comprising (i) a processor core having a native instruction set architecture associated therewith, the processor core for executing instructions coded in said native instruction set architecture; (ii) a key memory for storing a fixed, predetermined key associated with the computer system; (iii) a program memory for storing software programs coded in an alternative instruction set architecture which differs from said native instruction set architecture, said difference between said alternative instruction set architecture and said native instruction set architecture based on said fixed, predetermined key; and (iv) a translation unit for transforming instructions comprised in software programs coded in said alternative instruction set architecture into corresponding instructions coded in said native instruction set architecture, said transformed instructions for execution by said processor core, said transformation based on said fixed, predetermined key,
the method comprising the steps of:
retrieving from said program memory one or more instructions comprised in a software program coded in said alternative instruction set architecture and stored in said program memory;
transforming, with use of said translation unit, said one or more retrieved instructions into one or more corresponding instructions coded in said native instruction set architecture, said step of transforming based on said fixed, predetermined key; and
executing on said core processor said one or more corresponding instructions coded in said native instruction set architecture generated with use of said translation unit.

12. The method of claim 11 wherein the fixed, predetermined key is stored in a write-once memory.

13. The method of claim 12 wherein the fixed, predetermined key is accessed by the translation unit and is not accessible by user supplied software programs executable on said computer system.

14. The method of claim 11 wherein said instructions comprised in software programs coded in said alternative instruction set architecture comprise bitwise permutations of said corresponding instructions coded in said native instruction set architecture, said bitwise permutations being based on said fixed, predetermined key.

15. The method of claim 11 further comprising the step of executing a conversion utility to transform software programs coded in said native instruction set architecture into corresponding software programs coded in said alternative instruction set architecture, wherein said transformation of software programs by said conversion utility is based on said fixed, predetermined key.

16. The method of claim 15 further comprising the step of executing an operating system implemented as a software program coded in said alternative instruction set architecture, said operating system having been generated with use of said conversion utility.

17. The method of claim 15 wherein said conversion utility is implemented as a software program coded in said alternative instruction set architecture.

18. The method of claim 17 wherein the computer system is initially supplied with a minimal operating system and an initial conversion utility, each of which is implemented as a software program coded in said native instruction set architecture, the method further comprising the step of executing the minimal operating system and initial conversion utility on said processor core without use of said translation unit.

19. The method of claim 18 further comprising the steps of:
generating said conversion utility from said initial conversion utility with use of said initial conversion utility; and
generating a converted minimal operating system from said minimal operating system with use of said initial conversion utility, said converted minimal operating system implemented as a software program coded in said alternative instruction set architecture.

20. The method of claim 19 further comprising the steps of installing said fixed, predetermined key in said key memory and enabling use of said translation unit, after said converted minimal operating system has been generated from said minimal operating system and after said conversion utility has been generated from said initial conversion utility.
